(19) United States
(12) Patent Application Publication
(10) Pub. No.: US 2013/0013390 A1
(43) Pub. Date: Jan. 10, 2013

(54) Point of Sale System

(75) Inventors: Christopher PAULSON-ELLIS, Edinburgh (GB); Alastair CHISHOLM, Edinburgh (GB); Hamish MARTIN, Edinburgh (GB); Stuart BOUTELL, Edinburgh (GB); Robin Anthony IDDON, Edinburgh (GB); Richard MCBRIDE, Buntisland (GB)

(73) Assignee: EDESIX LIMITED, Edinburgh (GB)

(21) Appl. No.: 13/541,700

(22) Filed: Jul. 4, 2012

(30) Foreign Application Priority Data
Jul. 5, 2011 (GB) GB 1111460.0

(51) Int. Cl. G06Q 20/20; G06Q 30/02

(52) U.S. Cl. 705/14.38; 705/16; 705/21

(57) ABSTRACT

There is disclosed a system has a POS terminal comprising a display output interface and an identification input interface, the POS terminal being programmed: to receive identification data via the identification input interface, the identification data identifying a selected product for processing by the POS terminal, to process the identification data to generate alphanumeric text data encoding a description of the selected product, and to output the alphanumeric text data via the display output interface; a display unit; and a controller, programmed: to receive the alphanumeric text data from the POS terminal display output interface, to process the alphanumeric text data to generate further identification data identifying the selected product, to process the further identification data to select graphical data appropriate for the selected product, and to output the graphical data to the display unit. A controller, method, computer readable medium and computer are also disclosed.

### FIELD OF THE INVENTION

The present invention relates to a system and method for enhancing the functionality of a Point Of Sale (POS) terminal, and in particular relates to a controller for use with a POS terminal.

### BACKGROUND TO THE INVENTION

Many transactions in the retail industry, hospitality industry and elsewhere are automated using Point Of Sale (POS) systems. These systems register product details (for example using a barcode scanner or manually operated keypad), calculate a sale price, carry out financial transactions (for example by use of a credit card payment machine), and provide a record of the transaction (by way of a printed receipt, for example). In some environments, such as supermarket check-outs, more sophisticated systems are provided, capable of high throughput and great flexibility in terms of promotions that may be offered and on-the-fly discounting of items purchased, interactions with stock control systems, and so on.

At the heart of any POS system is a POS terminal, a combination of computer hardware and software that controls the operation of peripheral devices connected to the terminal. FIG. 1 is a schematic of a prior art Point Of Sale (POS) system that might be installed in a supermarket, for example. The system 100 includes a POS terminal 102, which is attached to a display unit 104 for displaying product details, a barcode scanner 106 for identifying products which are intended to be purchased, a card reader 108 for enabling payments to be made, a printer 110 for printing receipts, and a keypad 112 for manual entry of barcode numbers and other functions. Other peripherals, such as the cash draw lock (not shown) may also be controlled by the POS terminal 102.

FIG. 2 is an illustration of the display unit in the POS system of FIG. 1. The pictured display 200 is a common legacy fluorescent display type which displays two lines of alphanumeric text. In this case the top row of text 202 displays a product description (“GUINNESS”), referring for example to a can of Guinness®, and the bottom row of text 204 contains a price (“£2.40”). The display can only display a limited amount of text without any graphical elements.

FIG. 3 is a schematic showing the POS terminal of FIG. 1 in more detail. The POS terminal 300 may typically be a standard PC platform running custom software, and includes elements such as a processor 302, memory 304, storage 306 and input/output interfaces 308. Connected to the input/output interfaces 308 via standard serial port connections COM 0, COM 1, COM 2, and so on are the display unit 310, printer 312, barcode scanner 314, keypad 316, card payment processor 318 and various other peripherals 320 as desired, such as a magnetic swipe reader, for example. In different environments such as restaurants, product data may be entered via different means, such as remote terminals that may for example be wireless handheld devices.

Electronic cash registers (ECR) were the first examples of POS terminals. Different manufacturers used different proprietary hardware and software and different proprietary communication protocols. Later on generic PC hardware platforms replaced the proprietary platforms but many proprietary communications protocols have persisted in parallel, including for example the EPSON Esc/POS, UTC Standard, UTC Enhanced, AEDEX, ICD 2002, Ultimate, CD 5220, DSP-800 and ADM 787/788 standards. These standards are used to communicate between the POS terminal and the peripherals such as the display unit, receipt printer, and so on. Despite the differences between these standards, they all involve the transmission of alphanumeric text (with appropriate ‘escape codes’ to encode formatting information and the like) via a standard PC serial port connection, providing a relatively cheap, simple and efficient method of interconnecting POS system components.

Newer POS systems have been developed with greatly enhanced capabilities, including in some cases touch screen displays which are presented to the user so that the user can make selections relating to the transaction. This can, for example, allow cashier-less transactions in supermarkets and the like. These POS systems are very expensive, however, not least because they are still proprietary systems that require the replacement of the POS terminal and the display and possibly other elements of the system, with the POS terminal representing a significant proportion of the total upgrade cost. Accordingly, businesses using legacy systems with the earlier generation of text-based displays can find themselves unable to afford the price of upgrading to a newer system, or unwilling to accept the disruption caused by a wholesale replacement of their legacy systems (with attendant risks of incompatibility with other legacy systems such as stock control systems).

The present invention seeks to address problems in the above-mentioned prior art.

### SUMMARY OF THE INVENTION

The present invention provides a system for enhancing the functionality of a Point Of Sale (POS) terminal, the system comprising: a POS terminal comprising a display output interface (such as a serial port, USB interface, and so on) and an identification input interface (such as a further serial port, USB interface, and so on), the POS terminal being programmed: to receive identification data (such as a barcode scan, QR code, manually entered product ID, touch screen input, and so on) via the identification input interface, the identification data identifying a selected product for processing by the POS terminal, to process the identification data to generate alphanumeric text data encoding a description of the selected product, and to output the alphanumeric text data via the display output interface; a display unit (such as a computer monitor, touch screen display, tablet PC screen, and so on); and a controller, programmed: to receive the alphanumeric text data from the POS terminal display output interface, to process the alphanumeric text data to generate further identification data identifying the selected product, to process the further identification data to select graphical data appropriate for the selected product, and to output the graphical data to the display unit (for example via a digital video interface of some sort).

Accordingly, by providing an appropriate controller and display unit, the functionality of the POS terminal and the system as a whole can be enhanced without requiring the replacement of the POS terminal. The term “Point Of Sale” in relation to a terminal or system preferably connotes not only devices for carrying out transactions in the retail, hospitality and other sectors, but also analogous operations that may not necessarily involve a transfer of money or the change of ownership of a tangible product, such as the use of checkouts for stock control purposes, or transaction systems based on some form of credit or other non financial basis, or systems for loaning items rather than selling them, and so on. The term “alphanumeric text data” preferably connotes an ASCII style encoding of data using a defined number of bytes (such as 1 byte) to encode each letter, number or “special' character (such as punctuation and the like), for example in accordance with any of the EPSON Esc/POS, UTC Standard, UTC Enhanced, AEDEX, ICD 2002, Ultimate, CD 5220, DSP-800 and ADM 787/788 communication protocols.

The alphanumeric text data may also encode a price of the selected product.

The graphical data may comprise a promotional offer relating to the selected product. In this case, the controller may be further programmed to receive a user input accepting the promotional offer (or indeed refusing).

Alternatively or additionally, the controller may be further programmed to receive a user input comprising promotion identification data (such as a QR code, barcode, or the like), the promotion identification data identifying a promotional offer made available to the user. The controller may be operable to receive the user input from a device operated by the user, such as a mobile phone, portable PC, or a home computer (operated off-site, for example, in advance of the purchase). A code can for example be read from a user's mobile phone or the like by an optical reader (see below) if displayed on the screen as a QR code, barcode, numbers and the like, by a Bluetooth® connection, or by other means. The user can for example obtain a code on a mobile phone or the like by communicating with a server via the telecommunications network, for example by sending an SMS message or by using an inbuilt browser on the phone. Alternatively a code may be sent to a user's phone or computer unsolicited, for example as part of a store or brand loyalty programme, or otherwise in dependence on an analysis of the user's spending habits or in response to the user responding to an advertisement or promotion and the like.

In response to receiving the user input regarding the promotion, the controller is preferably further programmed to generate identification data relating to the promotional offer, and to transmit the identification data to the identification input interface of the POS terminal. The identification data may identify a further product for processing by the POS terminal (for example, a further product that is free or discounted according to the terms of the promotion), or it may identify a promotional code that, in use, can cause the POS terminal to vary its processing of at least one product (for example, by discounting the price of a particular item or class of items, or by enabling a 2-for-1 style offer or the like, and so on).

Preferably the identification data comprises barcode data, so that it can be transmitted to the POS terminal via a barcode scanner input, for example, thus requiring no new functionality to be provided in the POS terminal with regard to facilitating the promotions.

The aforesaid features relating to receiving a user input comprising promotion identification data may be provided independently of the aforesaid features relating to processing alphanumeric text data encoding a description of the selected product.

The controller may be further programmed to receive a user input comprising account identification data (in the form of a QR code, barcode, magnetic swipe, smart card interaction, or the like), the account identification data identifying a payment account associated with the user, and to transmit the account identification data to the POS terminal, for example via a magnetic stripe reader input or a barcode reader input, and the like. The controller may be further programmed to transmit the account identification data in a format suitable to cause the POS terminal to conduct a transaction using the identified account. The transaction may for example entail the deduction of funds from a pre-paid or other account, or the allocation of loyalty points to a loyalty point account associated with the user. These features may also be provided independently.

In other examples, the graphical data may comprise a still or moving picture relevant to the selected product, such as a photograph or video of the selected product, for example. This can help the user to identify the product in question and to verify that the correct transaction is taking place. The graphical data may also comprise an advertisement, which may for example be chosen for its relevance to the purchased product, the history of products scanned by the POS terminal, or a particular characteristic of the user or store location, for example.

In one embodiment the display unit and the controller unit are integrated into a single device. This could for example be an off-the-shelf (and suitably programmed) tablet or notebook computer, allowing the invention to be put into effect using no more than one computer, means for attaching the computer to the checkout (or other location), and connecting wires. This can provide a relatively simple and cost-effective upgrade for the POS terminal.

In another embodiment, the controller comprises an adaptor for attachment to the display output interface, and a further display output interface (such as some form of digital video interface) for outputting graphical display data to the display unit. In this arrangement, an off-the-shelf, unmodified display unit can be used, potentially saving cost and simplifying the installation and maintenance in case, for example, the display needs to be replaced or if there is an existing stock of appropriate displays, for example. The further display output interface may include a wireless transmitter for transmitting the graphical display data wirelessly to the display unit. The graphical display data may comprise rasterised bitmap data (for example in accordance with conventional digital video communication protocols) or, particularly in the case of the wireless transmission, reduced bandwidth video data such as compressed video data (using MPEG or other compression) and/or vector graphics data.

In a variant of the above embodiments, the system further comprises an adaptor for attachment to the display output interface of the POS terminal, the adaptor further comprising a controller interface (such as a serial port, USB interface, Ethernet or other network interface and the like) for outputting the alphanumeric text data to the controller. In this case, the controller interface may include a wireless transmitter for transmitting the alphanumeric text data wirelessly to the controller. This can allow the system to be upgraded without having to run a wired connection all the way between the POS terminal and the controller and display unit (which may, as noted, be incorporated within the same device), which can simplify the upgrade process.

In another embodiment, the controller is an executable code module stored in and executable by the POS terminal, and the display output interface is a virtual serial port that, in use, redirects the alphanumeric text data to the controller code module. (In different embodiments, the display output interface may be a normal, non-virtual computer serial port) This can remove the need for any separate hardware to be provided except for the upgraded display unit, and can allow the functionality of the POS terminal to be upgraded without necessarily making any changes at all to the proprietary/legacy software.

In any of the embodiments, the controller may be programmed to store sales data representing products that have been processed by the POS terminal. The controller may be programmed to transmit at least a portion of the sales data to a remote server (which may for example be a stock control server). Accordingly, stock control systems can be upgraded again without having to make any modifications to a legacy POS terminal. The controller may further be programmed to output display data representing at least a portion of the sales data. This can allow a user to browse the transaction history and, for example, to analyse trends and to view the effects of introducing new promotions and the like.

The controller may be further programmed to receive relationship data associating an item of graphical data with a product, and wherein processing the further identification data comprises processing the relationship data in dependence on the selected product. In other words, the user can use the controller (or other software/hardware) to specify which promotions, images, animations, advertisements, and so on, are to be displayed in connection with each product. The association can be a hard-coded correspondence between a product ID and a graphics ID, for example, or it may be specified by a variety of rules or by computer software that may, for example, select a particular graphic in dependence on the user's purchase history, demographics, location, and so on.

The display unit preferably comprises a touch screen for displaying a graphical output and receiving a user touch input, and is operable to transmit the user touch input to the controller. This can more easily facilitate the selection of a particular promotion, for example.

The display unit may comprise an optical reader for receiving a user optical input, and in that case is operable to transmit the user optical input to the controller. This can allow a user to input a selection of a promotion via a QR code or other image displayed on the user's phone, or via a printed promotion code, and the like.

In one embodiment the controller is operable to communicate with a plurality of POS terminals (and, correspondingly, may be operable to communicate with a respective plurality of display units). Thus, costs can be reduced even if the controller is relatively expensive, since providing one controller can remove the need to upgrade multiple POS terminals.

In a preferably related embodiment, the POS system further comprises a network and the controller is connected to the POS terminal via the network (preferably via a network-enabled adaptor that is connected to the POS terminal). The controller may also be connected to the display via the network, and may be located on a server. The controller may be connected to multiple POS terminals as in the above embodiment. This can further simplify maintenance and operation, as multiple sites may be managed from a single server/controller, for example, and the only hardware that may need to be installed on-site (other than the new displays) is the network interconnection between the POS terminals (via the above-mentioned adaptors, for example) and the server.

The POS terminal may be programmed to output data conforming to at least one of the EPSON Esc/POS, UTC Standard, UTC Enhanced, AEDEX, ICD 2002, Ultimate, CD 5220, DSP-800 and ADM 787/788 standards, or may use another, for example proprietary, standard.

In another aspect of the invention there is provided a controller for use with a POS terminal, the POS terminal comprising a display output interface and an identification input interface, and the POS terminal being programmed to receive identification data via the identification input interface, the identification data identifying a selected product for processing by the POS terminal, to process the identification data to generate alphanumeric text data encoding a description of the selected product, and to output the alphanumeric text data via the display output interface, wherein the controller is programmed: to receive the alphanumeric text data from the POS terminal display output interface, to process the alphanumeric text data to generate further identification data identifying the selected product, to process the further identification data to select graphical data appropriate for the selected product, and to output the graphical data to a display unit.

In a further aspect of the invention there is provided a controller for use with a POS terminal, the POS terminal comprising a display output interface and an identification input interface, and the POS terminal being programmed to receive identification data via the identification input interface, the identification data identifying a selected product for processing by the POS terminal, to process the identification data to generate alphanumeric text data encoding a description of the selected product, and to output the alphanumeric text data via the display output interface, wherein the controller comprises: an input module for receiving the alphanumeric text data from the POS terminal display output interface, an alphanumeric text processing module for processing the alphanumeric text data to generate further identification data identifying the selected product, a graphical data processing module for processing the further identification data to select graphical data appropriate for the selected product, and an output module for outputting the graphical data to a display unit.

All relevant features mentioned above in respect of the POS system may also be provided in conjunction with the controller embodiments mentioned above.

In another aspect of the invention there is provided a method of enhancing the functionality of a POS system including a POS terminal comprising a display output interface and an identification input interface, and the POS terminal being programmed to receive identification data via the identification input interface, the identification data identifying a selected product for processing by the POS terminal, to process the identification data to generate alphanumeric text data encoding a description of the selected product, and to output the alphanumeric text data via the display output interface, wherein the method comprises: receiving the alphanumeric text data from the POS terminal display output interface, processing the alphanumeric text data to generate further identification data identifying the selected product, processing the further identification data to select graphical data appropriate for the selected product, and outputting the graphical data to a display unit.

The method may further comprise receiving a user input accepting the promotional offer. The method may alternatively comprise receiving a user input comprising promotion identification data, the promotion identification data identifying a promotional offer made available to the user. The user input may be received from a device operated by the user. The method may further comprise generating, in response to receiving the user input, identification data relating to the promotional offer, and transmitting the identification data to the identification input interface of the POS terminal.

The method may further comprise transmitting graphical display data wirelessly to the display unit, and may further comprise receiving the alphanumeric text data from a controller interface of an adaptor that is attached to the display output interface, and may yet further comprise receiving the alphanumeric text data wirelessly from the adaptor.

The method may comprise receiving the alphanumeric text data from a virtual serial port associated with the display output interface, or it may comprise receiving the alphanumeric text data from a computer serial port.

The method may comprise storing sales data representing products that have been processed by the POS terminal, and may comprise transmitting at least a portion of the sales data to a remote server, or outputting display data representing at least a portion of the sales data, and/or receiving relationship data associating an item of graphical data with a product, and processing the relationship data in dependence on the selected product.

The method may further comprise receiving user touch input data from a touch screen associated with the display unit, and/or receiving user optical input data from an optical reader associated with the display unit.

The method may further comprise communicating with a plurality of POS terminals, and may further comprise communicating with the POS terminal via a network.

In another aspect of the invention there is provided a computer readable medium tangibly embodying computer program code which, when executed by the processor of a controller unit that also includes a memory, program store, data store and input/output interface, causes the controller unit to carry out a method as aforesaid.

In a further aspect of the invention there is provided a controller unit including a processor, memory, program store, data store and input/output interface, the program store containing computer program code which, when executed by the processor, causes the controller unit to carry out a method as aforesaid.

Although the embodiments of the invention described above with reference to the drawings comprise methods performed by computer apparatus, and also computer apparatus, the invention also extends to program instructions, particularly program instructions on or in a carrier, adapted for carrying out the processes of the invention or for causing a computer to perform as the computer apparatus of the invention. Programs may be in the form of source code, object code, a code intermediate source, such as in partially compiled form, or any other form suitable for use in the implementation of the processes according to the invention. The carrier may be any entity or device capable of carrying the program instructions.

For example, the carrier may comprise a storage medium, such as a ROM, for example a CD ROM or a semiconductor ROM, or a magnetic recording medium, for example a floppy disc, hard disc, or flash memory, optical memory, and so on. Further, the carrier may be a transmissible carrier such as an electrical or optical signal which may be conveyed via electrical or optical cable or by radio or other means. When a program is embodied in a signal which may be conveyed directly by cable, the carrier may be constituted by such cable or other device or means.

Although various aspects and embodiments of the present invention have been described separately above, any of the aspects and features of the present invention can be used in conjunction with any other aspect, embodiment or feature where appropriate. For example apparatus features may where appropriate be interchanged with method features.

### DESCRIPTION OF THE DRAWINGS

An example embodiment of the present invention will now be illustrated with reference to the following Figures in which:

FIG. 1 is a schematic of a prior art Point Of Sale (POS) system;

FIG. 2 is an illustration of a display unit for use with the POS system of FIG. 1;

FIG. 3 is a schematic of the POS terminal in the POS system of FIG. 1;

FIG. 4 is a schematic of a POS system in accordance with an embodiment of the present invention;

FIG. 5 is an illustration of a display unit for use with the POS system of FIG. 4;

FIG. 6 is an example of a promotion displayed on the display unit of FIG. 5;

FIG. 7 is an illustration of an embodiment of a POS system in which a controller and a display form part of a single display unit;

FIG. 8 is an illustration of another embodiment of a POS system in which a controller forms part of an adaptor that is attached to a POS terminal and a display;

FIG. 9 is an illustration of a yet further embodiment of a POS system in which a controller is provided as a software module executable by a POS terminal;

FIG. 10 is an illustration of a further embodiment of a POS system in which a controller is connected to an adaptor which in turn is connected to a POS terminal and display;

FIG. 11 is a schematic showing the POS system of FIG. 7 in more detail;

FIG. 12 is a schematic showing the POS system of FIG. 8 in more detail;

FIG. 13 is a schematic showing the POS system of FIG. 9 in more detail;

FIG. 14 is an illustration of the POS system of FIG. 11 being used in conjunction with a mobile phone and promotion server;

FIG. 15 is an illustration of a typical sequence of events taking place in the POS system of FIG. 7;

FIG. 16 is an illustration of the data stored in association with the controllers of the POS systems of FIGS. 7 to 9;

FIG. 17 is an illustration showing the program data of FIG. 16 in more detail;

FIG. 18 is an illustration showing the product data and graphics data of FIG. 16 in more detail;

FIG. 19 is a flowchart illustrating the operation of the controller of any of FIGS. 7 to 9 in response to receiving display output data from the POS terminal;

FIG. 20 is a flowchart illustrating the operation of the controller of any of FIGS. 7 to 9 in response to selecting a promotion to display;

FIG. 21 is a flowchart illustrating the operation of the controller of any of FIGS. 7 to 9 in response to receiving a user input agreeing to a promotion that has been displayed on the display;

FIG. 22 is a flowchart illustrating the operation of the controller of any of FIGS. 7 to 9 in response to a particular promotion being activated;

FIG. 23 is a flowchart illustrating the operation of the controller of any of FIGS. 7 to 9 in response to receiving a user selection of a promotion via an optical reader;

FIG. 24 is an illustration of a further embodiment of a POS system in which a POS terminal is connected to a networked server via an adaptor;

FIG. 25 is an illustration of a further embodiment of a POS system in which a plurality of POS terminals is connected to a networked server via respective adaptors; and

FIG. 26 is an illustration of a further embodiment of a POS system using a magnetic stripe reader input.

### DETAILED DESCRIPTION OF AN EXAMPLE EMBODIMENT

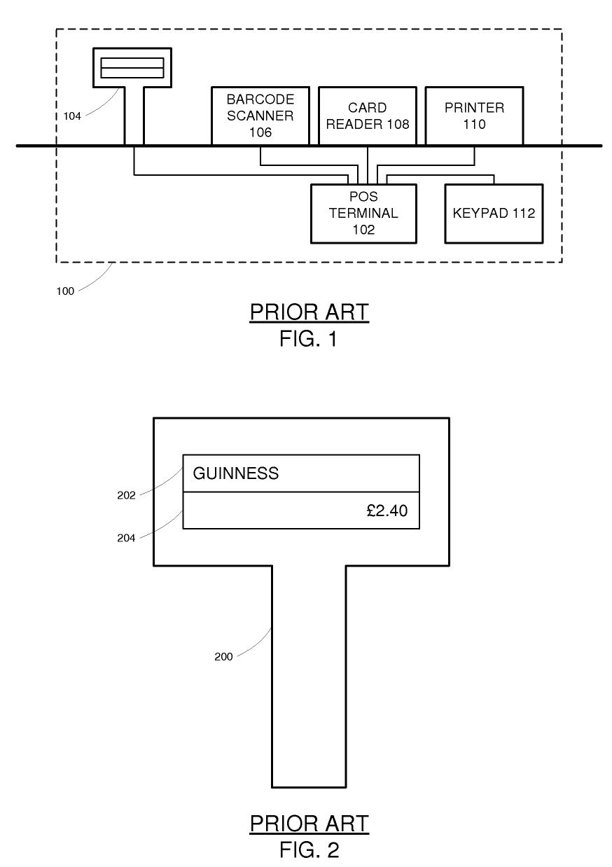

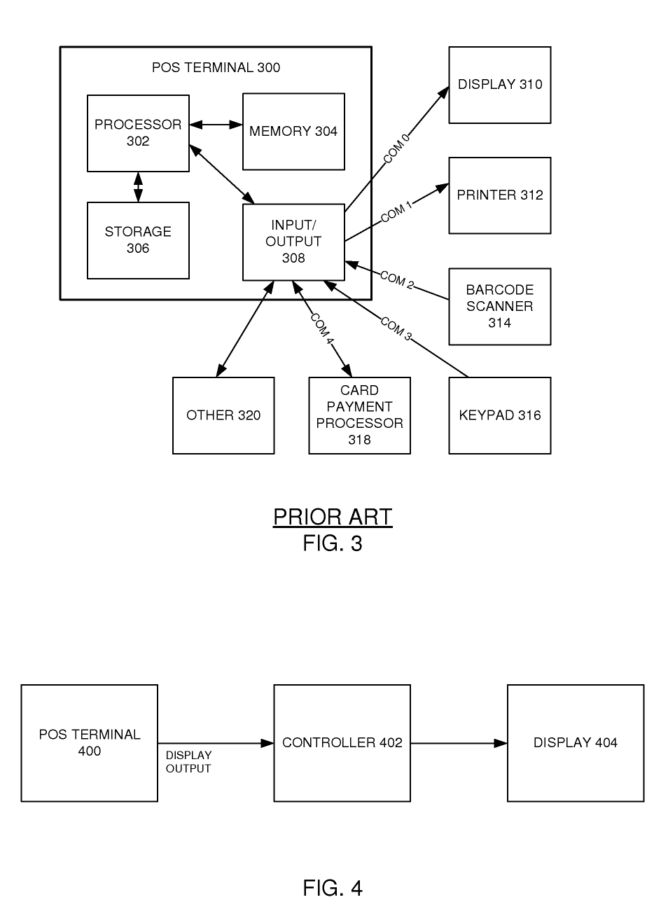

FIG. 4 is a schematic of a POS system in accordance with an embodiment of the present invention. This POS system includes a POS terminal 400, which is assumed to be a legacy cash register system based on a PC hardware platform and using a protocol such as CD 7220 to communicate with various peripherals, as described above in relation to the prior art system of FIGS. 1 to 3. In this embodiment, the display output interface of the POS terminal is connected to a controller unit 402 (instead of directly to a legacy POS display), and the controller unit 402 is in turn is connected to a display unit 404. The controller unit 402 interprets the serial data stream output by the POS terminal 400 and identifies a product based on the content of the data stream, based on the alphanumeric product description encoded in the stream and (if necessary to disambiguate) also the price of the item encoded in the stream. The controller then selects various graphical and/or text items corresponding to the product and outputs these to the display unit 404, taking advantage of the display unit's superior capabilities relative to the standard POS displays, which may for example be simple two-line text displays. Thus, the controller unit 402 takes a serial output data stream in proprietary, limited format, and replaces it with an improved output, completely transparently from the point of view of the POS terminal.

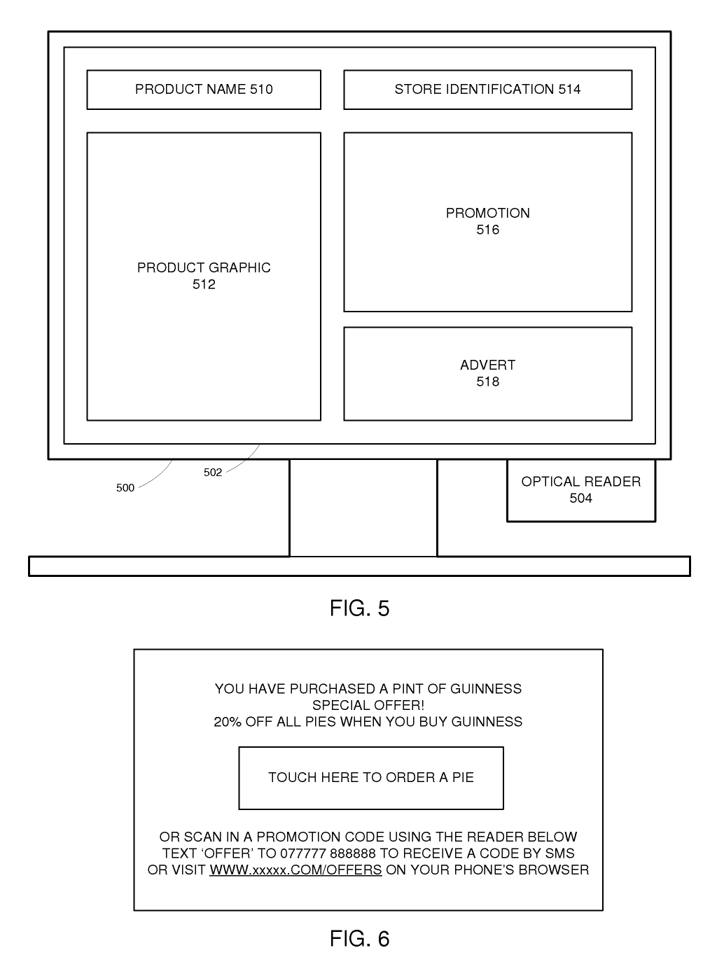

FIG. 5 is an illustration of a display unit for use with the POS system of FIG. 4. This shows a typical output on the display unit 500. The screen 502, which in this case is a touch screen, contains a number of visual elements, created by the controller unit mentioned above. An optical reader 504 is also provided, in this case below the screen, but other arrangements are of course possible (the reader does not need to be attached to or even in close proximity to the screen). The screen 502 includes a product name 510, a product graphic 512, a store identification text or graphic 514, a promotion 516, and an advert 518. Different screen layouts are of course possible, configured by the POS operator and/or in dependence on the product currently selected or other variable relating to the transaction.

In the example shown in FIG. 2, for example, a pint of Guinness® might have been scanned by the barcode scanner. The text transmitted by the POS terminal via the serial port associated with the legacy POS display contains the word “Guinness” and text representing the price “£2.40” and a number of special characters relating to the formatting of the text (including alignment commands, new line, tabs, and so on) which are specific to the communications standard (such as CD 7220) and which will not concern us here. Identifying the product by the “GUINNESS” text, the controller may consequently choose text such as “Can of Guinness” for the product name 510, and may choose a product shot of a can of Guinness® to fill the product graphic 512, for example. An advert 518 might be selected based on a demographic associated with Guinness® drinkers, for example, or may be related to some characteristic of the product. Overall, clearer and more complete information can be provided to the user, with various additional benefits.

The screen 502 may be generated by any appropriate means, and may in some variants be displayed by a web browser that is executing content local to the controller, remote from the controller, or a mixture of the two.

FIG. 6 is an example of a promotion displayed on the display unit of FIG. 5. In the present example where the POS operator has scanned a can of Guinness®, a promotion is chosen that in this case may be suitable for a restaurant or bar context. The customer is presented with an option to order a pie at a substantial discount, and is presented with an option to do so immediately by pressing the screen. Other methods of activating a promotion are listed and will be described in more detail below. If the user selects the promotion, the controller sends data back to the POS terminal to cause the promotion to be actioned by the POS terminal, again as described in more detail below.

There are a number of different ways to incorporate the controller into the legacy POS system, as will now be described.

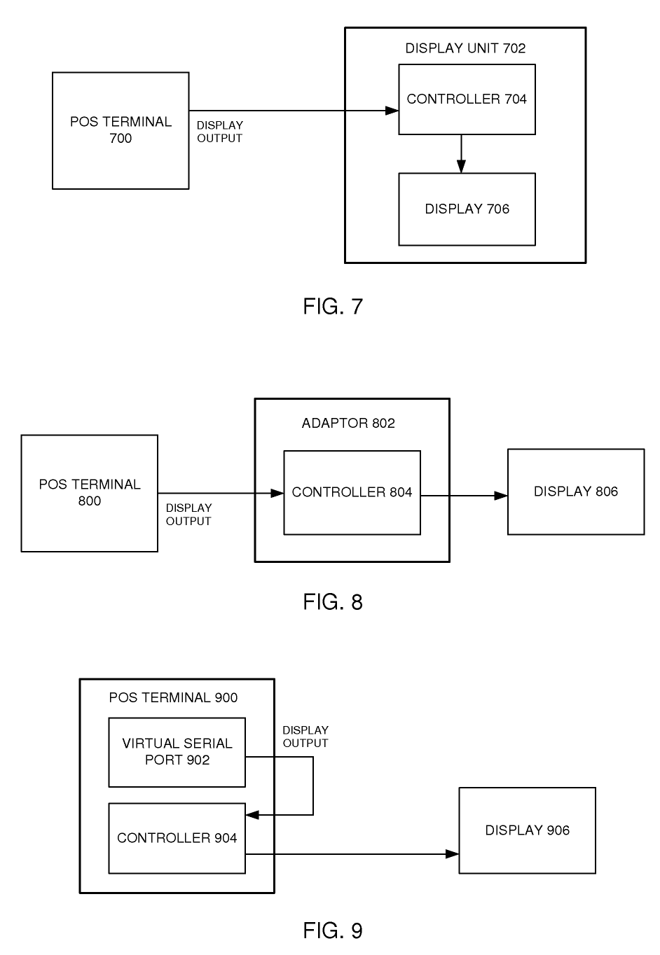

FIG. 7 is an illustration of an embodiment of a POS system in which a controller and a display form part of a single display unit. The display output interface (that is, the serial port that is normally attached to a POS display) of the POS terminal 700 is connected to the display unit 702. The controller processes the data from the POS terminal 700 and generates the graphics for the display 706. The display unit 702 may for example be a table or notebook PC or, for example, an iPad® or similar device, incorporating processing power, storage capacity, various input/output interfaces and a touch screen interface and display unit within a single package.

FIG. 8 is an illustration of another embodiment of a POS system in which a controller forms part of an adaptor that is attached to a POS terminal and a display. In this case the display output interface of a POS terminal 800 is connected to an adaptor 802 which includes a controller unit 804. The adaptor 802 in turn drives a display unit 806. In this case the adaptor may be a custom hardware component or may be standard computer hardware such as a standard PC platform. In this arrangement the display unit can be more slimline and/or more versatile as it does not need to incorporate any computing power.

FIG. 9 is an illustration of a yet further embodiment of a POS system in which a controller is provided as a software module executable by a POS terminal. In this case, the POS terminal 900 is unmodified in terms of hardware and software except that a virtual serial port 902 intercepts data otherwise destined for the display output interface, and redirects it to a controller unit 904, which is extra computer code executed by the POS terminal 900. The normal (usually proprietary) POS terminal software does not need to be altered since, from its perspective, the display data is being sent to the legacy display unit as always. This arrangement requires the least amount of extra hardware but is limited by the computing power and memory limits of the POS terminal 900. In this case, the controller software 904 drives the display 906 directly, for example via a graphics card in the POS terminal.

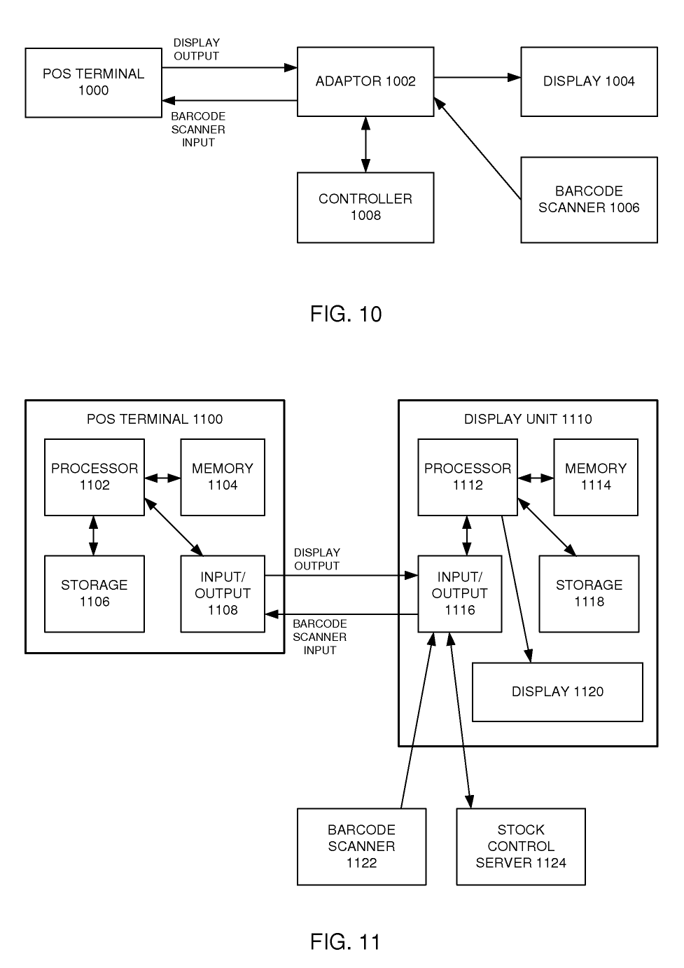

FIG. 10 is an illustration of a further embodiment of a POS system in which a controller is connected to an adaptor which in turn is connected to a POS terminal and display. In this case, the serial ports of the POS terminal 1000 are connected to an adaptor 1002 which is in turn connected to an advanced display 1004, the barcode scanner 1006 and a controller 1008. In this system, the adaptor redirects necessary data to and from the controller, but is otherwise a ‘dumb’ component which does not require significant computing power. The controller 1008 can therefore more easily be located elsewhere, for example in a dedicated computer room rather than taking up space at a checkout, for example. In this system, data output from the display serial port (display output) of the POS terminal is sent to the controller 1008 by the adaptor 1002, and graphical data output by the controller 1008 is sent to the display 1004 by the adaptor 1002 (or, in a variant, directly sent from the controller to the display). The barcode scanner 1006 data is passed directly through the adaptor 1002 to the barcode scanner serial port (barcode scanner input) of the POS terminal, but can be added to by the controller 1008, as described later on.

FIG. 11 is a schematic showing the POS system of FIG. 7 (in which the controller is integrated with the display) in more detail. The POS terminal 1100 includes a processor 1102, memory 1104, storage 1106 and input/output interfaces 1108 including the display output serial port and the barcode scanner input serial port. The display unit 1110 includes a processor 1112, memory 1114, input/output interfaces 1116, storage 1118 and a display 1120 (typically a touch screen). In this example the barcode scanner 1122 connects to the display unit 1110, but in a variant the barcode scanner plugs directly into the POS terminal 1100, optionally via an adaptor. A stock control server 1124 is also shown, in communication with the display unit 1110 as will again be described in more detail later on.

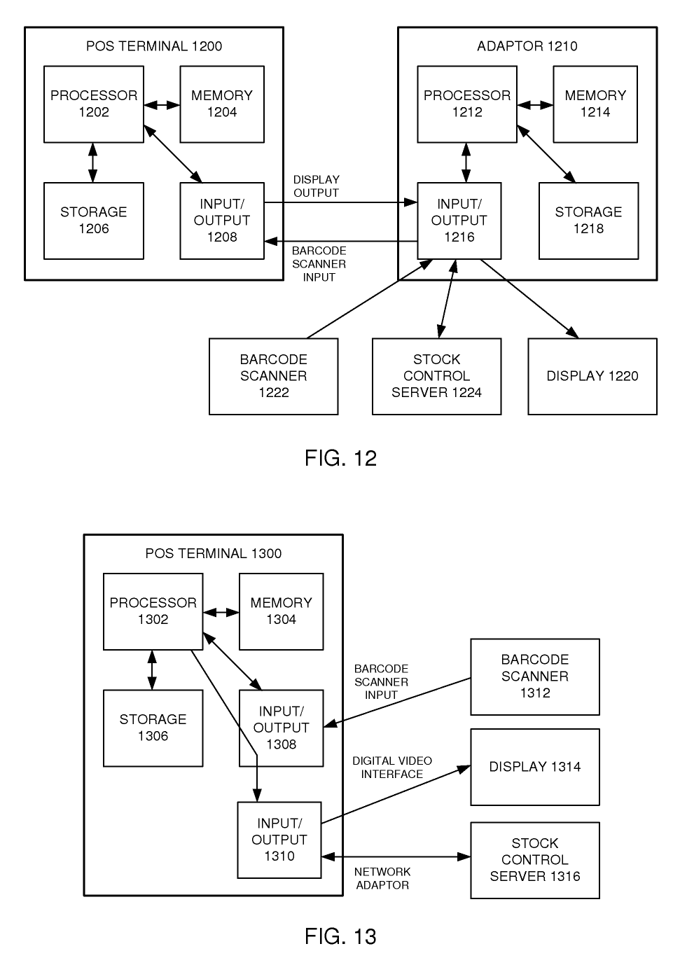

FIG. 12 is a schematic showing the POS system of FIG. 8 (in which the controller is provided in an adaptor that connects between the POS terminal and the display unit) in more detail. The POS terminal 1200 includes a processor 1202, memory 1204, storage 1206 and input/output interfaces 1208. The adaptor 1210 includes a processor 1212, memory 1214, input/output interfaces 1216 and storage 1218. The adaptor 1210 is connected to a display unit 1220, barcode scanner 1222, and stock control server 1224. As before, in one variant the barcode scanner can be plugged directly into the POS terminal.

FIG. 13 is a schematic showing the POS system of FIG. 9 (in which the controller is provided as computer program code on the POS terminal) in more detail. The POS terminal 1300 includes a processor 1302, memory 1304, storage 1306, legacy input/output interfaces 1308, and additional input/output interfaces 1310, including for example a digital video interface and (optionally) network connector. A barcode scanner 1312, display 1314 and (optionally) stock control server 1316 are connected to the POS terminal 1300.

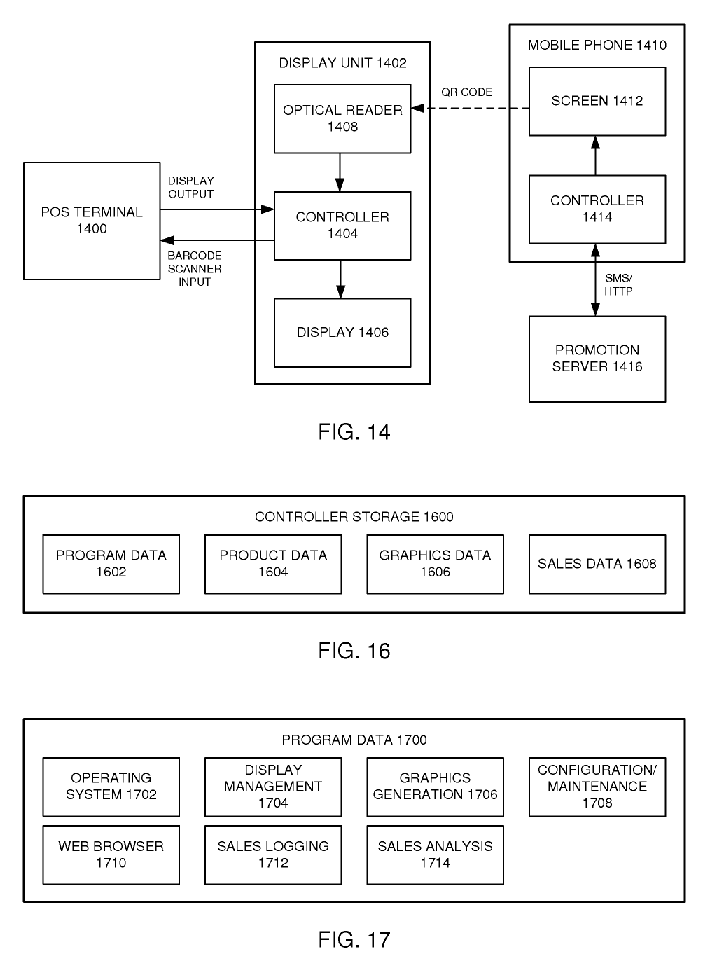

FIG. 14 is an illustration of the POS system of FIG. 11 (the embodiment in which the controller and display are integrated) being used in conjunction with a mobile phone and promotion server. In this example a POS terminal 1400, display unit 1402, including a controller 1404, display 1406 and optical reader 1408, a mobile phone 1410, including a screen 1412, mobile phone controller 1414, and a promotion server 1416 are provided. It will be appreciated that this arrangement can be adapted, with appropriate modification, for use with the other embodiments described above.

As foreshadowed by the text shown in FIG. 6, a system can be provided whereby a user can send a text (SMS) message to a particular number, or navigate to a particular HTTP address, to obtain a number of promotion codes. Alternatively promotion codes may be actively ‘pushed’ to the user. The codes can be provided in a form that can be printed out or displayed on the screen of a phone or other portable device, for example as a web page, graphical MMS message, JPEG or other static image, PDF form, and so on. These promotion codes may be given if particular criteria are met, for example if a user has purchased a particular number of related items or joined a particular loyalty scheme, or may be freely available, for example in exchange for sending a premium rate text message. The codes may typically be QR codes (2D barcodes), normal barcodes, or any other format that can be read by an optical reader (or, alternatively, a magnetic reader or be entered by any other kind of input device, such as manual entry of numbers and/or letters via a keypad or touch screen, for example).

In the example shown in FIG. 14, a user communicates via the promotion server 1416 via SMS message or web browser to request a promotional code relating to a particular product, and an HTTP link is sent to the user's mobile phone 1410. Opening the link causes a web page to be displayed which contains a QR code. With the web page open, the screen 1412 of the phone 1410 is scanned by the optical reader 1408, and the controller 1404 converts the QR code into a promotional code. The relevant promotion can then be displayed on the display 1406 for the user's further consideration and, if appropriate, be transmitted to the POS terminal 1400.

The transmission of a promotion to the POS terminal 1400 is achieved by converting the promotional offer into a barcode that either represents a particular product or a particular promotion code that has been pre-programmed into the POS terminal. The barcode is then sent to the barcode scanner input serial port of the POS terminal 1400, which causes the POS terminal to respond as if that barcode had been manually scanned by the POS operator.

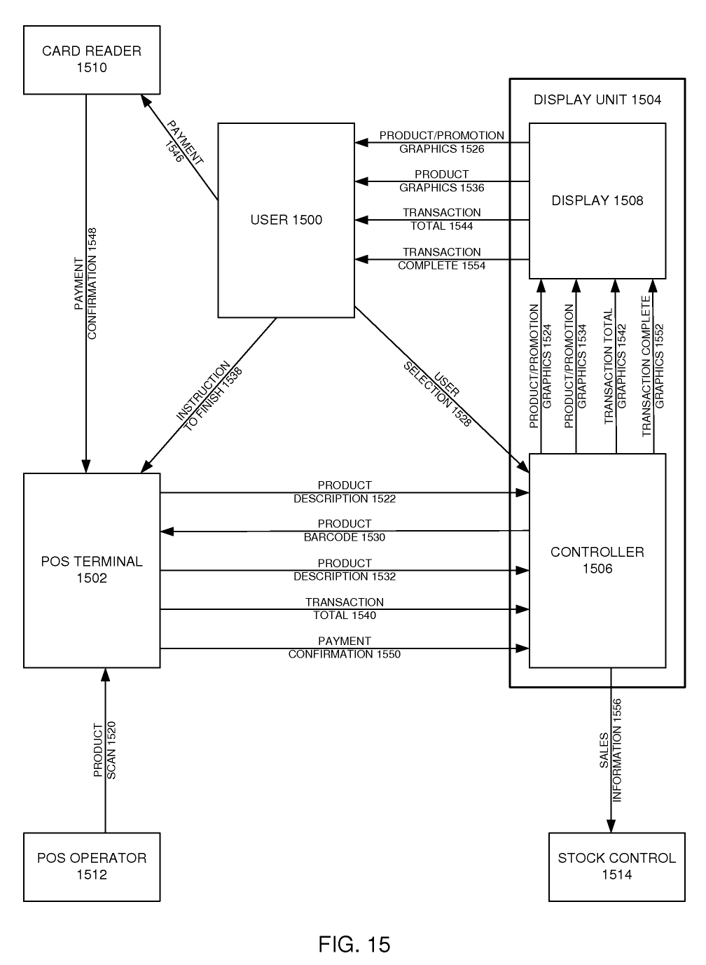

FIG. 15 is an illustration of a typical sequence of events taking place in the POS system of FIG. 7. The user (consumer) 1500, POS terminal 1502, display unit 1504 (including controller 1506 and display 1508), card reader 1510, POS operator 1512 and stock control server 1514 are shown.

The POS operator commences the process by scanning a product 1520, causing barcode data to be sent to the barcode scanner input serial port (by whatever route). A product description 1522 formatted for a legacy POS display is then sent to the controller, which converts it into product and promotion graphics 1524 which is displayed on the display. The user can then see the product/promotion graphics 1526 and act on it. In this instance, the user makes a selection 1528 to accept the promotion on offer, and the selection is registered by the controller. The controller determines a barcode that will activate the promotion and transmits it 1530 to the POS terminal, in this case causing a product to be registered by the POS terminal. This in turn causes the new product description to be transmitted 1532 to the controller which, as before, turns the new product description into a graphical display 1534 which the display shows 1536 to the user. The user, now content with the selection of items, gives an instruction 1538 to the POS terminal (via the operator) that the transaction is now complete. A total amount is then rung up by the POS terminal and sent 1540 to the controller. The controller then generates appropriate graphics 1542 to pass this information on 1544 to the user via the display. The user effects payment 1546 via the card reader, which sends an acknowledgement 1548 to the POS terminal, and a final output 1550 is sent by the POS terminal to the controller to indicate that the payment has completed. Again, suitable graphics are generated 1552 and displayed 1554 to the user. In a final step, the controller communicates with the stock control computer and sends a summary 1556 of the completed transaction so that stock levels can be adjusted.

FIG. 16 is an illustration of the data stored in association with the controllers of the POS systems of FIGS. 7 to 9. The controller storage 1600 includes program data 1602, product data 1604, graphics data 1606 and sales data 1608, but other data may be stored depending on the circumstances.

FIG. 17 is an illustration showing the program data of FIG. 16 in more detail. The program data 1700 includes operating system code 1702 (for providing a platform for the other software modules), display management code 1704 (for driving the display), graphics generation code 1706 (for selecting and combining graphical elements), configuration/maintenance code 1708 (for specifying associations between products and graphical elements such as promotions, for adding and deleting promotions, and so on), web browser code 1710 (for variants where the graphics are displayed by a web browser), sales logging code 1712 (for storing details of completed transactions for possible forwarding to a stock control computer or otherwise for data mining), sales analysis code 1714 (for analysing past transaction data and for viewing the effectiveness of promotions and the like), and any other code as required.

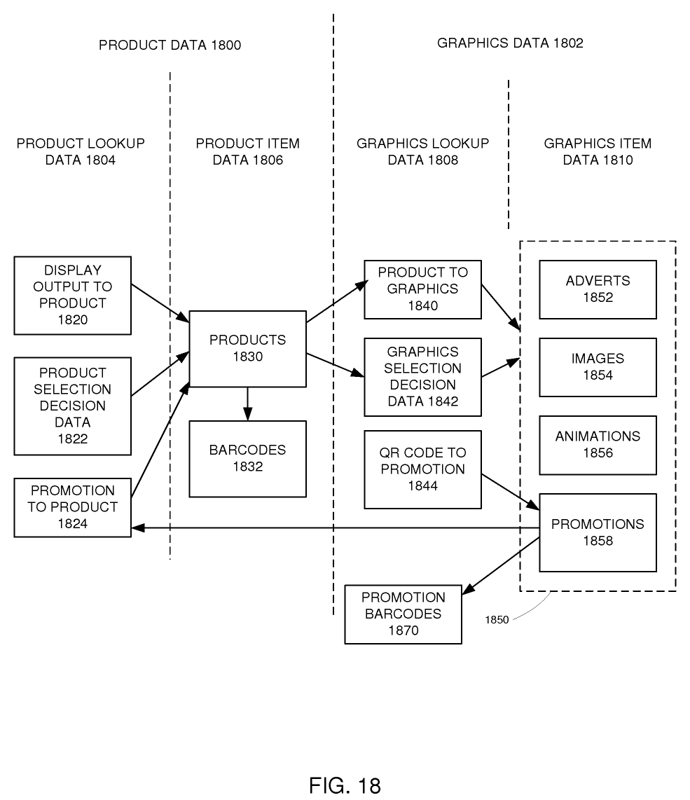

FIG. 18 is an illustration showing the product data and graphics data of FIG. 16 in more detail. The product data 1800 and graphics data 1802 are divided into product lookup data 1804, product item data 1806, graphics lookup data 1808 and graphics item data 1810, although other arrangements of data are of course possible. The relationship between different data elements is indicated by arrows.

The display output to product table 1820 is a look-up table relating keywords in the display output data (that is, the alphanumeric text output by the POS terminal) to particular products (identified by a product ID field). For more sophisticated matching (for example disambiguating where necessary based on prices as well as descriptions) the product selection decision data 1822 contains rules, scripts and/or executable code that can be executed with the display output data as an input (as well as other information as required) and provides a selected product ID as an output. The promotion to product table 1824 links a particular promotion to one or more products (via a product ID field). The products data 1830 includes various characteristics for each product, including product name, and the barcodes data 1832 links allows products to be identified back to the POS terminal by way of the barcode entry system (as described above). The product to graphics table 1840 is another look-up table relating product IDs to graphics elements (any of adverts, images, animations, promotions, and so on). As with the data 1822, the graphics selection decision data 1842 provides more sophisticated matching between products and graphical elements and may comprise rules, scripts and/or executable code. In variants, separate data and tables may be provided in respect of each graphical element, so that there may be for example a separate table for matching products to promotions. The QR code to promotion table 1844 links QR codes provided by a user to particular promotions. In variants a similar table is provided for other forms of input, such as barcodes, numbers, pass phrases, and so on. The graphics data 1850 includes adverts 1852, images 1854, animations 1856, and promotions 1858, although different installations may require different combinations of elements and may omit or add to these categories. A further table is provided of promotion barcodes 1870 which can be used to activate various discounts and the like when transmitted to the POS terminal.

In different embodiments, not all of the data structures mentioned above are required, and other structures may be provided, for example including additional types of data.

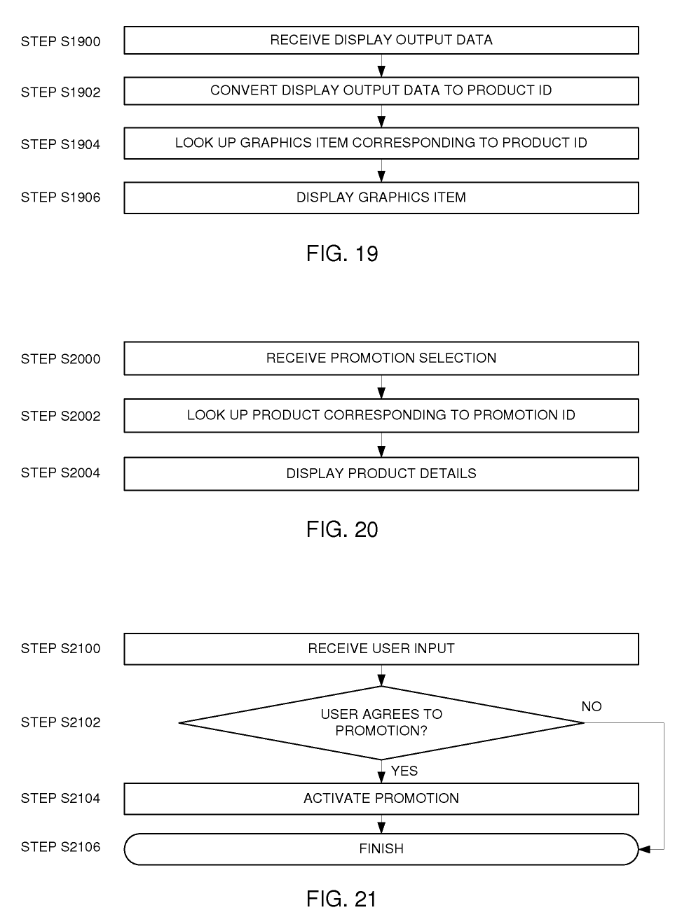

FIG. 19 is a flowchart illustrating the operation of the controller of any of FIGS. 7 to 9 in response to receiving display output data from the POS terminal. In step S1900 display output data (that is, alphanumeric text) is received from the POS terminal. The output data is converted (S1902) to a product ID, for example by recognising particular keywords in the alphanumeric text. A graphics item corresponding to the product ID is selected (S1904) and displayed (S1906), and the process may be repeated (not shown) for further graphics items.

FIG. 20 is a flowchart illustrating the operation of the controller of any of FIGS. 7 to 9 in response to selecting a promotion to display. In step S2000 a product is selected corresponding to a particular promotion ID, and in step S2002 the relevant product details are displayed, typically within the ‘promotion’ portion of the screen.

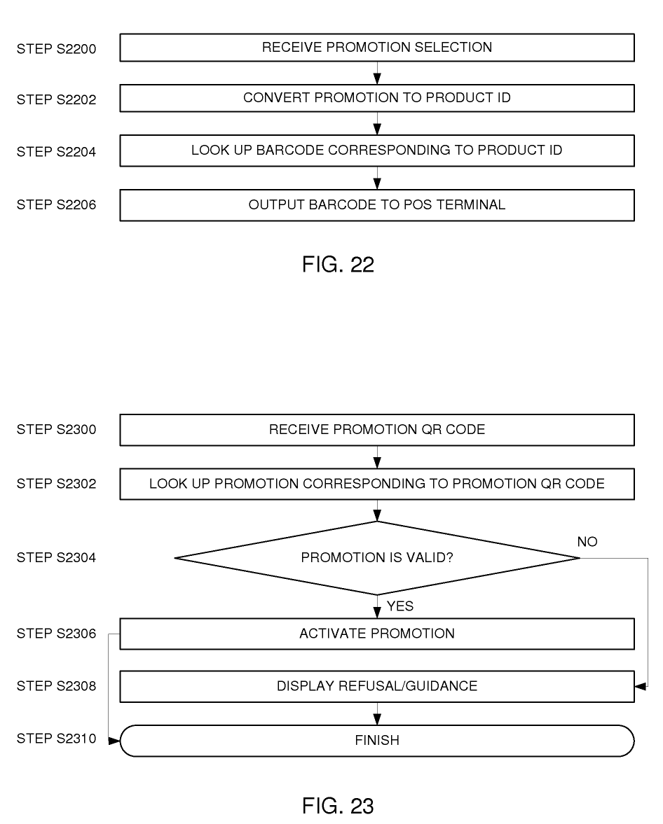

FIG. 21 is a flowchart illustrating the operation of the controller of any of FIGS. 7 to 9 in response to receiving a user input agreeing to a promotion that has been displayed on the display. In step S2100, user input is received regarding the promotion. The user input may be considered to be an absence of any input for a particular duration of time. If the user agrees (S2102) to the promotion, the promotion is activated (S2104), which is described in more detail below in relation to FIG. 22. Otherwise the promotion process finishes directly (S2106).

FIG. 22 is a flowchart illustrating the operation of the controller of any of FIGS. 7 to 9 in response to a particular promotion being activated. This flowchart assumes that the promotion relates to a particular product, although in some cases it does not and a general promotion identifier is transmitted instead to the POS terminal. In step S2200, a selection of a particular promotion (typically by reference to a promotion ID) is received. The promotion is converted to a product ID (S2202), and a barcode is selected (S2204) corresponding to the particular product ID. This barcode is then output (S2206) to the POS terminal.

FIG. 23 is a flowchart illustrating the operation of the controller of any of FIGS. 7 to 9 in response to receiving a user selection of a promotion via an optical reader. In step S2300, a QR code (or other code as described above) is received from a user (consumer), for example by scanning the screen of a mobile phone. A promotion is identified that corresponds to the QR code (S2302). If the promotion is valid (S2304), the promotion is activated (S2306), in respect of which see above regarding FIG. 22. Otherwise, an appropriate refusal or guidance is displayed (S2308), and the process finishes (S2310).

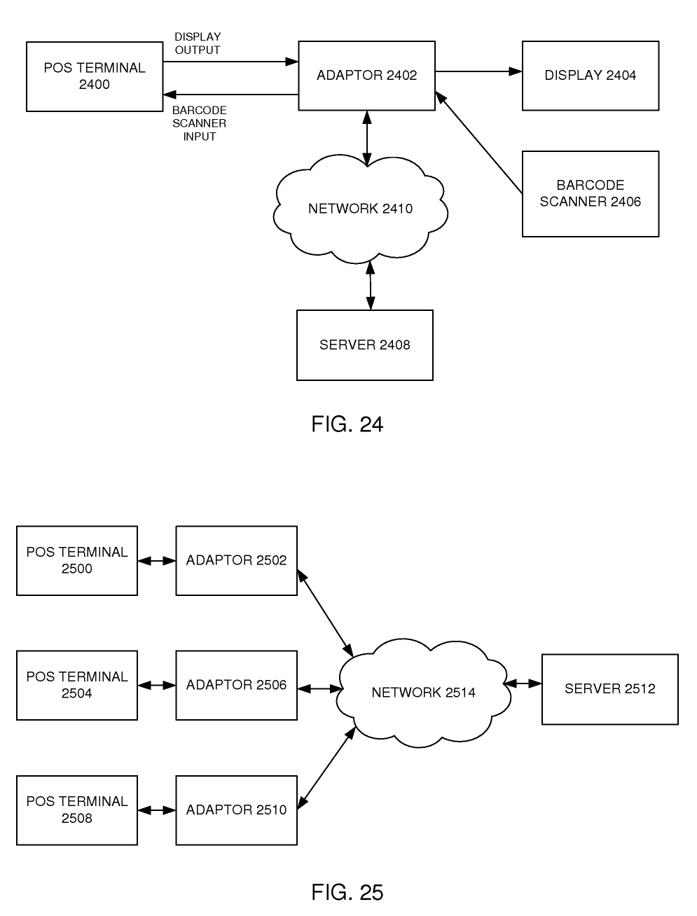

FIG. 24 is an illustration of a further embodiment of a POS system in which a POS terminal is connected to a networked server via an adaptor. In this embodiment, the POS terminal 2400, adaptor 2402, display 2404, barcode scanner 2406 and server 2408 are interconnected by a network 2410. The controller can be located in the adaptor 2402 or server 2408 or in a mixture of the two, as appropriate.

FIG. 25 is an illustration of a further embodiment of a POS system in which a plurality of POS terminals is connected to a networked server via respective adaptors. A first POS terminal 2500, first adaptor 2502, second POS terminal 2504, second adaptor 2506, third POS terminal 2508, third adaptor 2510 and a server 2512 are again interconnected by a network 2514. Appropriate displays (not shown) are also provided as before for each POS terminal. Further or fewer adaptors and POS terminals can be provided as appropriate. In this embodiment, a single server (incorporating most or all of the functions of the aforementioned controller) can provide enhanced functionality for a plurality of POS systems, improving the efficiency of the operation and reducing the amount of additional hardware required to upgrade the system. In a variant, the adaptors 2502, 2506, 2510 retain some graphical generation functionality of the controllers in order to reduce the bandwidth of data transmissions across the network 2514.

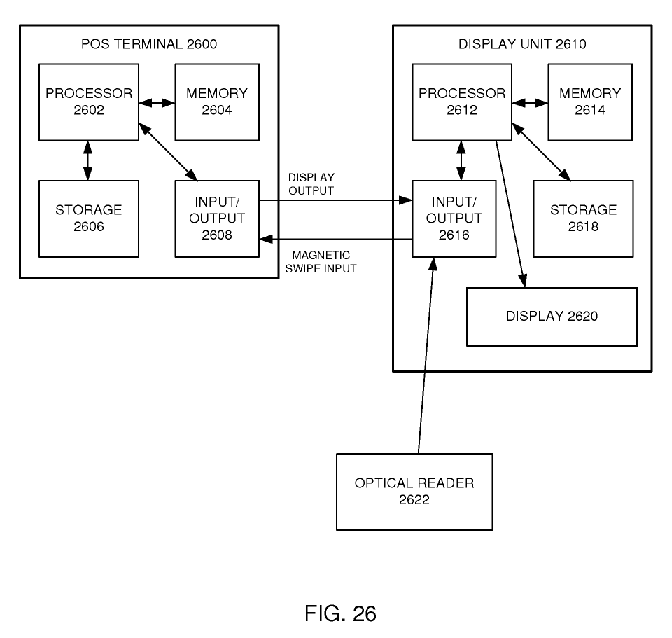

FIG. 26 is an illustration of a further embodiment of a POS system using a magnetic stripe reader input. The POS terminal 2600 includes a processor 2602, memory 2604, storage 2606 and input/output interfaces 2608 including the display output serial port and the barcode scanner input serial port. The display unit 2610 includes a processor 2612, memory 2614, input/output interfaces 2616, storage 2618 and a display 2620 (typically a touch screen). An optical reader 2622 connects to the display unit 2610, and can read QR codes, or equivalent code that includes a (preferably unique) identifier. In a variant other types of reader may be provided, such as an RFID reader, for example. As before, a barcode reader and other input devices may be provided (not shown) and may or may not be routed via the display unit 2610 or (in a variant) an adaptor, and so on.

In this system, when a purchase is made the user can show a QR code (or equivalent identifier as discussed above) to indicate an action. The QR code may for example be a loyalty identifier, causing ‘store points’ or the like to be attributed to the user. Alternatively the code can be used to pay for the purchase, for example via a pre-paid account that is associated with the presented identifier (in QR code format or otherwise). The user can load cash into the pre-paid account from a standard credit card or bank account, for example. In this case, the QR code presented at the correct point will signify to the POS (via the display unit 2610) that the owed amount should be decremented from the pre-paid account associated with the QR code. The display unit 2610 (or equivalent) is configured to convert the QR code into a format suitable for the POS terminal 2600 (in some cases it may present the QR code unchanged but in others a suitable magnetic swipe string format may be generated and passed to the terminal 2600). It will be appreciated that the principles described elsewhere in relation to other POS terminal inputs such as bar code reader inputs can be applied where appropriate to the magnetic swipe reader input, and vice versa. In this case, the POS is preferably configured to connect to a magnetic swipe reader via a serial port or a USB port.

Although the present invention has been described above with reference to specific embodiments, it will be apparent to a skilled person in the art that modifications lie within the spirit and scope of the present invention.

1. A system for enhancing the functionality of a Point Of Sale, POS, terminal, the system comprising:
a POS terminal comprising a display output interface and an identification input interface, the POS terminal being programmed: to receive identification data via the identification input interface, the identification data identifying a selected product for processing by the POS terminal,
to process the identification data to generate alphanumeric text data encoding a description of the selected product, and to output the alphanumeric text data via the display output interface;
a display unit; and
a controller, programmed:
to receive the alphanumeric text data from the POS terminal display output interface,
to process the alphanumeric text data to generate further identification data identifying the selected product,
to process the further identification data to select graphical data appropriate for the selected product, and
to output the graphical data to the display unit.

2. A system according to claim 1, wherein the graphical data comprises a promotional offer relating to the selected product.

3. A system according to claim 2, wherein the controller is further programmed to receive a user input accepting the promotional offer.

4. A system according to claim 1, wherein the controller is further programmed to receive a user input comprising promotion identification data, the promotion identification data identifying a promotional offer made available to the user.

5. A system according to claim 4, wherein the controller is operable to receive the user input from a device operated by the user.

6. A system according to claim 3, wherein the controller is further programmed to generate, in response to receiving the user input, identification data relating to the promotional offer, and to transmit the identification data to the identification input interface of the POS terminal.

7. A system according to claim 6, wherein the identification data identifies a further product for processing by the POS terminal.

8. A system according to claim 6, wherein the identification data identifies a promotional code that, in use, can cause the POS terminal to vary its processing of at least one product.

9. A system according to claim 6, wherein the identification data comprises barcode data.

10. A system according to claim 1, wherein the graphical data comprises a still or moving picture relevant to the selected product or the graphical data comprises an advertisement.

11. A system according to claim 1, wherein the display unit and the controller are integrated into a single device.

12. A system according to claim 1, wherein the controller comprises an adaptor for attachment to the display output interface, and a further display output interface for outputting graphical display data to the display unit.

13. A system according to claim 12, wherein the further display output interface includes a wireless transmitter for transmitting the graphical display data wirelessly to the display unit.

14. A system according to claim 1, further comprising an adaptor for attachment to the display output interface, the adaptor further comprising a controller interface for outputting the alphanumeric text data to the controller.

15. A system according to claim 14, wherein the controller interface includes a wireless transmitter for transmitting the alphanumeric text data wirelessly to the controller.

16. A system according to claim 1, wherein the controller is an executable code module stored in and executable by the POS terminal, and the display output interface is a virtual serial port that, in use, redirects the alphanumeric text data to the controller code module.

17. A system according to claim 1, wherein the display output interface is a computer serial port.

18. A system according to claim 1, wherein the controller is programmed to store sales data representing products that have been processed by the POS terminal.

19. A system according to claim 18, wherein the controller is programmed to transmit at least a portion of the sales data to a remote server or the controller is programmed to output display data representing at least a portion of the sales data.

20. A system according to claim 1, wherein the controller is further programmed to receive relationship data associating an item of graphical data with a product, and wherein processing the further identification data comprises processing the relationship data in dependence on the selected product.

21. A system according to claim 1, wherein the display unit comprises a touch screen for displaying a graphical output and receiving a user touch input, and is operable to transmit user touch input data to the controller or the display unit comprises an optical reader for receiving a user optical input, and is operable to transmit user optical input data to the controller.

22. A system according to claim 1, wherein the controller is operable to communicate with a plurality of POS terminals.

23. A system according to claim 1, further comprising a network and wherein the controller is connected to the POS terminal via the network.

24. A system according to claim 1, wherein the POS terminal is programmed to output data conforming to at least one of the EPSON Esc/POS, UTC Standard, UTC Enhanced, AEDEX, ICD 2002, Ultimate, CD 5220, DSP-800 and ADM 787/788 standards.

25. A controller for use with a POS terminal, the POS terminal comprising a display output interface and an identification input interface, and the POS terminal being programmed to receive identification data via the identification input interface, the identification data identifying a selected product for processing by the POS terminal, to process the identification data to generate alphanumeric text data encoding a description of the selected product, and to output the alphanumeric text data via the display output interface, wherein the controller is programmed:
to receive the alphanumeric text data from the POS terminal display output interface,
to process the alphanumeric text data to generate further identification data identifying the selected product,
to process the further identification data to select graphical data appropriate for the selected product, and
to output the graphical data to a display unit.

26. A controller according to claim 25, wherein the graphical data comprises a promotional offer relating to the selected product.

27. A controller according to claim 26, wherein the controller is further programmed to receive a user input accepting the promotional offer.

28. A controller according to claim 25, wherein the controller is further programmed to receive a user input comprising promotion identification data, the promotion identification data identifying a promotional offer made available to the user.

29. A controller according to claim 28, wherein the controller is operable to receive the user input from a device operated by the user.

30. A controller according to claim 27, wherein the controller is further programmed to generate, in response to receiving the user input, identification data relating to the promotional offer, and to transmit the identification data to the identification input interface of the POS terminal.

31. A controller according to claim 30, wherein the identification data identifies a further product for processing by the POS terminal.

32. A controller according to claim 30, wherein the identification data identifies a promotional code that, in use, can cause the POS terminal to vary its processing of at least one product.

33. A controller according to claim 30, wherein the identification data comprises barcode data.

34. A controller according to claim 25, wherein the graphical data comprises a still or moving picture relevant to the selected product or the graphical data comprises an advertisement.

35. A controller according to claim 25, wherein the controller is integrated with the display unit into a single device.

36. A controller according to claim 25, wherein the controller comprises an adaptor for attachment to the display output interface, and a further display output interface for outputting graphical display data to the display unit.

37. A controller according to claim 36, wherein the further display output interface includes a wireless transmitter for transmitting the graphical display data wirelessly to the display unit.

38. A controller according to claim 25, wherein the controller is operable to receive the alphanumeric text data from a controller interface of an adaptor that is attached to the display output interface.

39. A controller according to claim 38, wherein the controller includes a wireless receiver for receiving the alphanumeric text data wirelessly from the adaptor.

40. A controller according to claim 25, wherein the controller is an executable code module stored in and executable by the POS terminal, and the controller is operable to receive the alphanumeric text data from a virtual serial port associated with the display output interface.

41. A controller according to claim 25, wherein the controller is operable to receive the alphanumeric text data from a computer serial port.

42. A controller according to claim 25, wherein the controller is programmed to store sales data representing products that have been processed by the POS terminal.

43. A controller according to claim 42, wherein the controller is programmed to transmit at least a portion of the sales data to a remote server or the controller is programmed to output display data representing at least a portion of the sales data.

44. A controller according to claim 25, wherein the controller is further programmed to receive relationship data associating an item of graphical data with a product, and wherein processing the further identification data comprises processing the relationship data in dependence on the selected product.

45. A controller according to claim 25, wherein the controller is programmed to receive user touch input data from a touch screen associated with the display unit or the controller is programmed to receive user optical input data from an optical reader associated with the display unit.

46. A controller according to claim 25, wherein the controller is operable to communicate with a plurality of POS terminals.

47. A controller according to claim 25, wherein the controller is connected to the POS terminal via a network.

48. A controller according to claim 25, wherein controller is programmed to receive display output data conforming to at least one of the EPSON Esc/POS, UTC Standard, UTC Enhanced, AEDEX, ICD 2002, Ultimate, CD 5220, DSP-800 and ADM 787/788 standards.

49. A controller for use with a POS terminal, the POS terminal comprising a display output interface and an identification input interface, and the POS terminal being programmed to receive identification data via the identification input interface, the identification data identifying a selected product for processing by the POS terminal, to process the identification data to generate alphanumeric text data encoding a description of the selected product, and to output the alphanumeric text data via the display output interface, wherein the controller comprises:
an input module for receiving the alphanumeric text data from the POS terminal display output interface,
an alphanumeric text processing module for processing the alphanumeric text data to generate further identification data identifying the selected product,
a graphical data processing module for processing the further identification data to select graphical data appropriate for the selected product, and
an output module for outputting the graphical data to a display unit.

50. A method of enhancing the functionality of a POS system including a POS terminal comprising a display output interface and an identification input interface, and the POS terminal being programmed to receive identification data via the identification input interface, the identification data identifying a selected product for processing by the POS terminal, to process the identification data to generate alphanumeric text data encoding a description of the selected product, and to output the alphanumeric text data via the display output interface, wherein the method comprises:
receiving the alphanumeric text data from the POS terminal display output interface,
processing the alphanumeric text data to generate further identification data identifying the selected product,
processing the further identification data to select graphical data appropriate for the selected product, and
outputting the graphical data to a display unit.

51. A method according to claim 50, wherein the graphical data comprises a promotional offer relating to the selected product.

52. A method according to claim 50, further comprising receiving a user input accepting the promotional offer.

53. A method according to claim 50, further comprising receiving a user input comprising promotion identification data, the promotion identification data identifying a promotional offer made available to the user.

54. A method according to claim 53, wherein the user input is received from a device operated by the user.

55. A method according to claim 52, further comprising generating, in response to receiving the user input, identification data relating to the promotional offer, and transmitting the identification data to the identification input interface of the POS terminal.

56. A method according to claim 55, wherein the identification data identifies a further product for processing by the POS terminal.

57. A method according to claim 55, wherein the identification data identifies a promotional code that, in use, can cause the POS terminal to vary its processing of at least one product.

58. A method according to claim 55, wherein the identification data comprises barcode data.

59. A method according to claim 50, wherein the graphical data comprises a still or moving picture relevant to the selected product or the graphical data comprises an advertisement.

60. A method according to claim 50, further comprising transmitting graphical display data wirelessly to the display unit.

61. A method according to claim 50, further comprising receiving the alphanumeric text data from a controller interface of an adaptor that is attached to the display output interface.

62. A method according to claim 61, further comprising receiving the alphanumeric text data wirelessly from the adaptor.

63. A method according to claim 50, further comprising receiving the alphanumeric text data from a virtual serial port associated with the display output interface.

64. A method according to claim 50, further comprising receiving the alphanumeric text data from a computer serial port.

65. A method according to claim 50, further comprising storing sales data representing products that have been processed by the POS terminal.

66. A method according to claim 65, further comprising transmitting at least a portion of the sales data to a remote server or outputting display data representing at least a portion of the sales data.

67. A method according to claim 50, further comprising receiving relationship data associating an item of graphical data with a product, and processing the relationship data in dependence on the selected product.

68. A method according to claim 50, further comprising receiving user touch input data from a touch screen associated with the display unit or receiving user optical input data from an optical reader associated with the display unit.

69. A method according to claim 50, further comprising communicating with a plurality of POS terminals.

70. A method according to claim 50, further comprising communicating with the POS terminal via a network.

71. A method according to claim 50, further comprising receiving display output data conforming to at least one of the EPSON Esc/POS, UTC Standard, UTC Enhanced, AEDEX, ICD 2002, Ultimate, CD 5220, DSP-800 and ADM 787/788 standards.

72. A computer readable medium tangibly embodying computer program code which, when executed by the processor of a controller unit that also includes a memory, program store, data store and input/output interface, causes the controller unit to carry out the method of claim 50.

73. A controller unit including a processor, memory, program store, data store and input/output interface, the program store containing computer program code which, when executed by the processor, causes the controller unit to carry out the method of claim 50.
